(19) United States
(12) Patent Application Publication
(10) Pub. No.: US 2026/0268216 A1
(43) Pub. Date: Sep. 10, 2026

(54) GENERATION DEVICE, GENERATION METHOD, AND RECORDING MEDIUM

(71) Applicant: NEC Corporation, Tokyo (JP)

(72) Inventor: Tomoki NAGAHAMA, Tokyo (JP)

(73) Assignee: NEC Corporation, Tokyo (JP)

(21) Appl. No.: 19/465,134

(22) Filed: Jan. 30, 2026

(30) Foreign Application Priority Data
Mar. 4, 2025 (JP) 2025-033546

(51) Int. Cl. G06N 20/00; G06N 5/04

(52) U.S. Cl. CPC G06N 20/00; G06N 5/04

(57) ABSTRACT

A generation device for generating training data includes a question answer generation unit that generates, based on data representing a history of the conversation, data representing the question, data representing a final answer that is a final answer to the question, and data representing an intermediate answer including information included in the answer output before outputting the final answer, and an inference process generation unit that refers to the intermediate answer and generates data representing an inference process from the question to the final answer based on the question and the final answer, in which the training data includes, as first training data, a plurality of sets of data representing the question as an input to the trained model, data representing the final answer as an output from the trained model, and data representing the inference process.

### CROSS REFERENCE TO RELATED APPLICATION

This application is based upon and claims the benefit of priority from Japanese Patent Application No. 2025-33546, filed on Mar. 4, 2025, the disclosure of which is incorporated herein in its entirety by reference.

### TECHNICAL FIELD

The present disclosure relates to a generation device and the like.

### BACKGROUND ART

JP 2022-145124 A describes the following information processing device for the purpose of improving the accuracy of a natural language processing program. In the information processing device described in JP 2022-145124 A, a program synthesis (PS) model training unit trains the PS model using the first training data including the correct answer data. The natural language processing (NP) model training unit performs machine learning on the NP model so that the program estimated by the NP model is similar to the program estimated by the PS model. Here, the first training data includes the input text, the application command string, and the application result. The application command string is one or more programs to be executed (applied) to the input text, and is prepared in advance by the user or the like for each task for the sentence to be processed.

### SUMMARY

An object of the present disclosure is to provide a generation device, a generation method, and a program that solves the above- described problems.

A generation device according to one aspect of the present disclosure is a generation device for generating training data for fine-tuning of a trained model that simulates a conversation with a user in a natural language, inputs data representing a question issued from the user and data representing feedback from the user, and generates and outputs data representing an answer to the question. The generation device includes a question answer generation unit that generates, based on data representing a history of the conversation, data representing the question, data representing a final answer that is a final answer to the question, and data representing an intermediate answer including information included in the answer output before outputting the final answer, and an inference process generation unit that refers to the intermediate answer and generates data representing an inference process from the question to the final answer based on the question and the final answer. The training data includes, as first training data, a plurality of sets of data representing the question as an input to the trained model, data representing the final answer as an output from the trained model, and data representing the inference process.

A generation method according to one aspect of the present disclosure is a generation method for generating training data for fine-tuning of a trained model that simulates a conversation with a user in a natural language, inputs data representing a question issued from the user and data representing feedback from the user, and generates and outputs data representing an answer to the question. The generation method includes a step of generating, based on data representing a history of the conversation, data representing the question, data representing a final answer that is a final answer to the question, and data representing an intermediate answer including information included in the answer output before outputting the final answer, a step of referring to the intermediate answer and generating data representing an inference process from the question to the final answer based on the question and the final answer, and a step of generating the training data including, as first training data, a plurality of sets of data representing the question as an input to the trained model, data representing the final answer as an output from the trained model, and data representing the inference process.

A non-transitory recording medium according to an aspect of the present disclosure has recorded therein a program for generating training data for fine-tuning of a trained model that simulates a conversation with a user in a natural language, inputs data representing a question issued from the user and data representing feedback from the user, generates and outputs data representing an answer to the question. The program causes the computer to execute a step of generating, based on data representing a history of the conversation, data representing the question, data representing a final answer that is a final answer to the question, and data representing an intermediate answer including information included in the answer output before outputting the final answer, a step of referring to the intermediate answer and generating data representing an inference process from the question to the final answer based on the question and the final answer, and a step of generating the training data including, as first training data, a plurality of sets of data representing the question as an input to the trained model, data representing the final answer as an output from the trained model, and data representing the inference process.

### BRIEF DESCRIPTION OF THE DRAWINGS

Exemplary features and advantages of the present disclosure will become apparent from the following detailed description when taken with the accompanying drawings in which:

FIG. 1 is a configuration diagram of a generation device according to the present disclosure;

FIG. 2 is a configuration diagram of a trained model according to the present disclosure;

FIG. 3 is a configuration diagram of a model training unit according to the present disclosure;

FIG. 4 is a configuration diagram of a question answer generation unit according to the present disclosure;

FIG. 5 is a configuration diagram of a background information extraction unit according to the present disclosure;

FIG. 6 is a configuration diagram of an inference process generation unit according to the present disclosure;

FIG. 7 is a configuration diagram of an inference process evaluation unit according to the present disclosure;

FIG. 8 is a schematic diagram illustrating an example of a conversation history according to the present disclosure;

FIG. 9 is a schematic diagram illustrating an example of a question and an answer according to the present disclosure;

FIG. 10 is a schematic diagram illustrating an example of background information according to the present disclosure;

FIG. 11 is a schematic diagram illustrating an example of a first inference process according to the present disclosure;

FIG. 12 is a schematic diagram illustrating an example of a second inference process according to the present disclosure;

FIG. 13 is a schematic diagram illustrating an example of a conversation history according to the present disclosure;

FIG. 14 is a schematic diagram illustrating an example of a question and an answer according to the present disclosure;

FIG. 15 is a schematic diagram illustrating an example of background information according to the present disclosure;

FIG. 16 is a schematic diagram illustrating an example of a first inference process according to the present disclosure;

FIG. 17 is a configuration diagram of a generation device according to the present disclosure;

FIG. 18 is a flowchart of a generation method according to the present disclosure; and

FIG. 19 is a configuration diagram of a computer according to the present disclosure.

### EXAMPLE EMBODIMENT

Hereinafter, an example embodiment according to the present disclosure will be described with reference to the drawings. In all the drawings, the same or related components are denoted by the same reference signs, and the common description will be omitted.

### First Example Embodiment

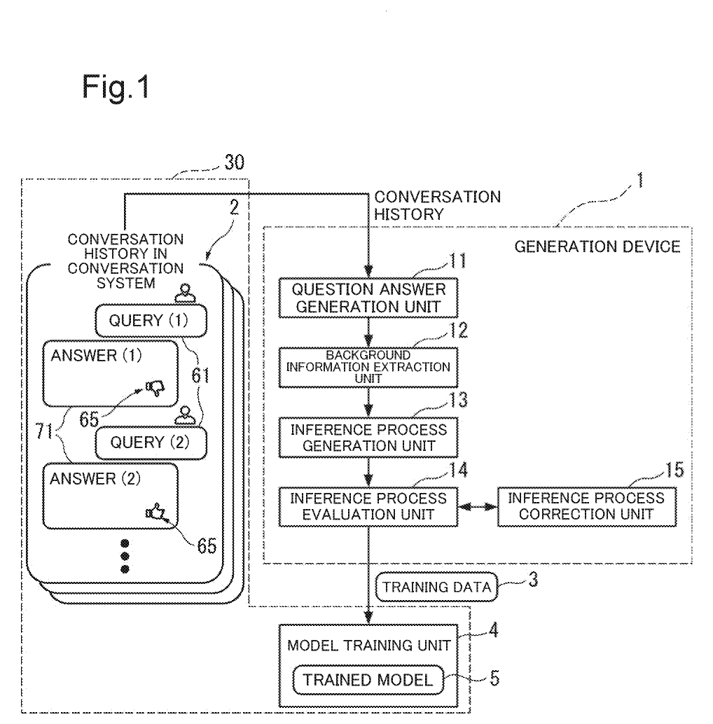

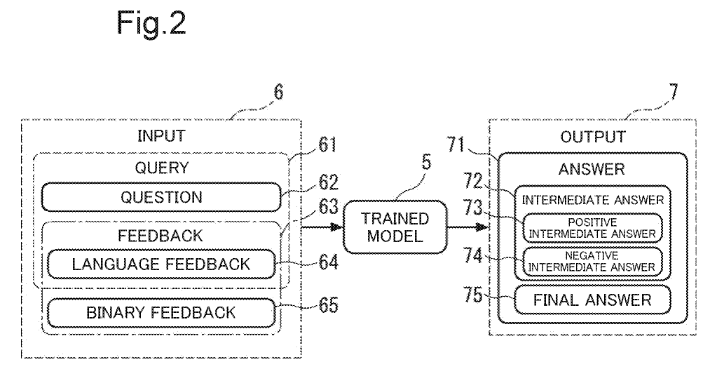

Hereinafter, one example embodiment according to the present disclosure will be described with reference to the drawings. FIG. 1 is a configuration diagram of a generation device according to the present disclosure. FIG. 2 is a configuration diagram of a trained model according to the present disclosure. A generation device 1 illustrated in FIG. 1 is a device that inputs data 2 representing a conversation history in a conversation (interactive) system 30 configured using a trained model 5 and generates training data 3 for fine-tuning of the trained model 5. Here, the conversation system is a system in which a human and a computer interact using a natural language.

The trained model 5 is a machine learning model trained to simulate interacting with a user in a natural language. As illustrated in FIG. 2, the trained model 5 inputs, as input data 6, data 62 representing a question issued from the user and data 63 representing feedback from the user, generates data 71 representing an answer to the question represented by the data 62 representing the question, and outputs the data as output data 7. The trained model 5 generates and outputs, for example, data 75 representing a correct final answer in a first response with respect to the data 62 representing the question input from the user, or generates and outputs the data 75 representing a correct final answer through a plurality of times of input and output with the user. The trained model 5 is, for example, a trained model having a neural network as an element, and weighting coefficients between neurons of each layer of the neural network are optimized by machine learning so that data representing a solution to be obtained is output for a large number of input data. The trained model 5 includes, for example, a combination of a program for performing calculation from input to output and a weighting coefficient (parameter) used for the calculation.

In the following description, for example, each piece of data such as the data 2 representing the conversation history, the data 62 representing the question, and the data 71 representing the answer is also referred to as the conversation history 2, the question 62, the answer 71, and the like while omitting words of “data representing”. In the present example embodiment, “data” means both a case of one data and a case of a plurality of data (data group). For example, the question 62 means two cases of a case where the data is one data representing the question and a case where the data is a plurality of data each representing a question. However, for example, in a case where the data 62 representing the question is individually distinguished, each piece of data is distinguished by adding a symbol “-” to the end of a reference numeral “62” attached to the question such as the questions 62-1 and 62-2.

As illustrated in FIG. 1, the conversation history 2 includes one or more queries 61 input by the user and one or more answers 71 generated by the trained model 5. A conversation history 2 illustrated in FIG. 1 indicates that an answer (1) is returned to a query (1) input by a user, and an answer (2) is returned to a query (2) input next. In the present example embodiment, the exchange of a query 61 and an answer 71 is also referred to as conversation.

As illustrated in FIG. 2, the input data 6 of the trained model 5 includes a question 62 and a feedback 63. The feedback 63 is a reaction, an opinion, an impression, or the like from the user to the answer, and includes a language feedback 64 and a binary feedback 65. The language feedback 64 is feedback in a natural language. The binary feedback 65 is feedback representing the degree of the user's evaluation as either a binary value such as high evaluation or low evaluation. In the example illustrated in FIG. 1, the binary feedback 65 is represented by an icon representing “good” or “bad”.

In the input data 6, as illustrated in FIG. 1, the question 62 is relevant to one of the queries 61 (for example, the query (1)) (or is included in one or a plurality of queries 61) in the conversation history 2. For example, the language feedback 64 is included in the query 61 (for example, the query (2)) that does not include the question 62. As illustrated in FIG. 1, for example, the binary feedback 65 is input so as to be relevant to the answer 71 for each answer 71. However, the conversation history 2 can also include the answer 71 to which the binary feedback 65 is not input.

As illustrated in FIG. 2, the output data 7 of the trained model 5 includes the answer 71. In the present example embodiment, the data representing the answer 71 is classified into either the data 72 representing the intermediate answer or the data 75 representing the final answer. The data 72 representing the intermediate answer is classified into data 73 representing a positive intermediate answer and data 74 representing a negative intermediate answer. The final answer 75 is a final answer to the question that the question 62 represents. The intermediate answer 72 includes information included in the answer 71 output before outputting the final answer. The positive intermediate answer 73 is the correct answer 71 included in the conversation until outputting the final answer. A negative intermediate answer 74 is an incorrect answer 71 included in the conversation until outputting the final answer.

Returning to FIG. 1, the generation device 1 can be configured using, for example, a computer such as one or a plurality of servers. The generation device 1 includes a question answer generation unit 11, a background information extraction unit 12, an inference process generation unit 13, an inference process evaluation unit 14, and an inference process correction unit 15 as functional blocks including a combination of hardware such as a computer and software such as a program executed by the computer. As described above, the generation device 1 inputs the conversation history 2, and generates and outputs the training data 3 for fine-tuning of the trained model 5. The training data 3 generated by the generation device 1 is used by the model training unit 4 to fine-tune the trained model 5. In FIG. 1, the model training unit 4 is provided in the conversation system 30, but may be provided in the generation device 1. The conversation system 30 may include, for example, the generation device 1.

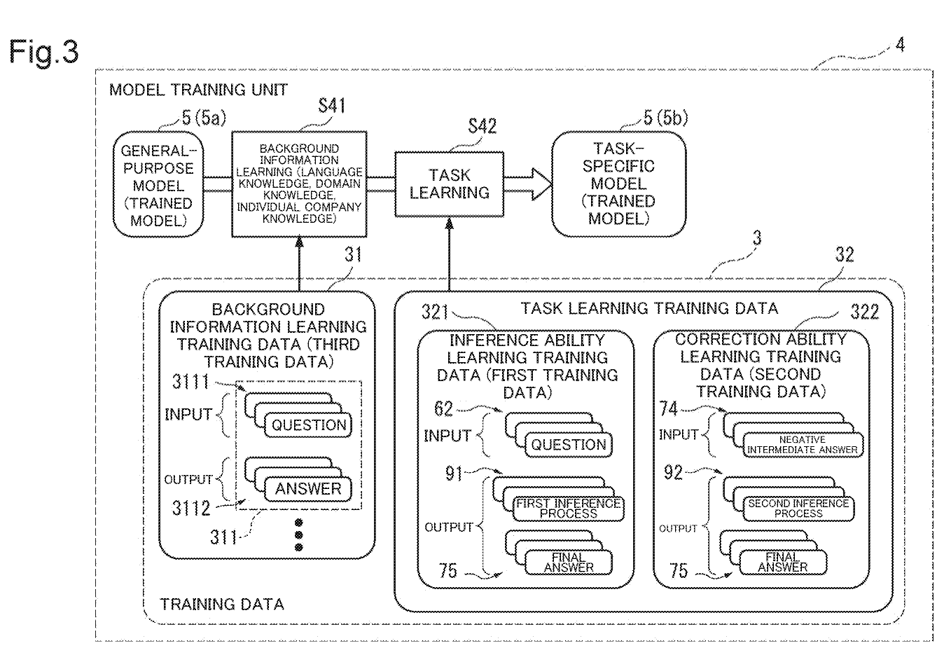

Fine-tuning of the trained model 5 using the training data 3 by the model training unit 4 will be described with reference to FIG. 3. In the present example embodiment, fine-tuning in machine learning is a process of additionally training a trained model (trained machine learning model) trained in advance using a unique data set prepared for a specific task or the like. In the present example embodiment, the training data 3 includes background information learning training data 31 and task learning training data 32.

As illustrated in FIG. 3, the model training unit 4 first performs background information learning, which is supervised machine learning, using the background information learning training data 31 on the general-purpose model 5a (trained model 5 before fine-tuning), which is a trained model machine-learned using a general-purpose data set for a general conversation system (S41). In the background information learning (S41), the trained model 5 is caused to learn background information that is general information of a field to which the conversation system 30 is applied so that the trained model 5 can generate an appropriate answer 71. The background information includes general information classified into a plurality of categories such as language knowledge (technical terms, programming languages, and the like), domain knowledge, and individual company knowledge (specific knowledge of a use company). The background information learning training data 31 includes one or a plurality of pieces of training data 311, for each category, including a plurality of sets of data in which a question 3111 is input data of the trained model 5 and a correct answer 3112 is output data of the trained model 5. For example, the model training unit 4 performs background information learning by designating a category (S41). The set of the question 3111 and the correct answer 3112 included in the background information learning training data 31 is, for example, a set of a question having a lower difficulty level and a correct answer than the set of the question (question 62) and the correct answer (final answer 75) included in the task learning training data 32. The background information learning training data 31 is a configuration example of “third training data” of the present disclosure. The question 3111 is a configuration example of the “query (inquiry) of the background information” of the present disclosure. The correct answer 3112 is a configuration example of the “answer (response) (of the background information)” of the present disclosure. How to generate the background information learning training data 31 will be described later.

Next, the model training unit 4 performs task learning (S42), which is supervised machine learning, using the task learning training data 32 on the trained model 5 on which background information learning (S41) has been performed, and generates a task-specific model 5b (trained model 5 after fine-tuning). In the task learning (S42), the trained model 5 is caused to learn information regarding a task, which is information regarding the question 62, the final answer 75, and the like based on the conversation history 2, so that the trained model 5 can generate an appropriate final answer 75.

The task learning training data 32 includes inference ability learning training data 321 and correction ability learning training data 322. The inference ability learning training data 321 is data including a plurality of sets of data in which the question 62 is input data of the trained model 5 and the first inference process 91 and the final answer 75 for the question 62 are output data of the trained model 5. The first inference process 91 includes information indicating an inference process from the question 62 to the final answer 75. The correction ability learning training data 322 is data including a plurality of sets of data in which the negative intermediate answer 74 is input data of the trained model 5 and the second inference process 92 and the final answer 75 for the negative intermediate answer 74 are output data of the trained model 5. The second inference process 92 includes information indicating an inference process from the negative intermediate answer 74 to the final answer 75. The inference ability learning training data 321 is a configuration example of “first training data” of the present disclosure. The correction ability learning training data 322 is a configuration example of “second training data” of the present disclosure. How to generate the first inference process 91 and the second inference process 92 will be described later. The training data 3 may not include any one of the background information learning training data 31 and the task learning training data 32. The task learning training data 32 may not include any one of the inference ability learning training data 321 and the correction ability learning training data 322.

As stepwise learning, the model training unit 4 first learns with the background information learning training data 31, and then learns with the task learning training data 32. According to this configuration, learning is stabilized by learning in stages from a simple question to a difficult question. It is possible to learn the correction ability by setting the output of a correct final answer from an erroneous answer as training data. By using the inference process as the output of the training data, it is possible to learn the inference ability for a complicated question.

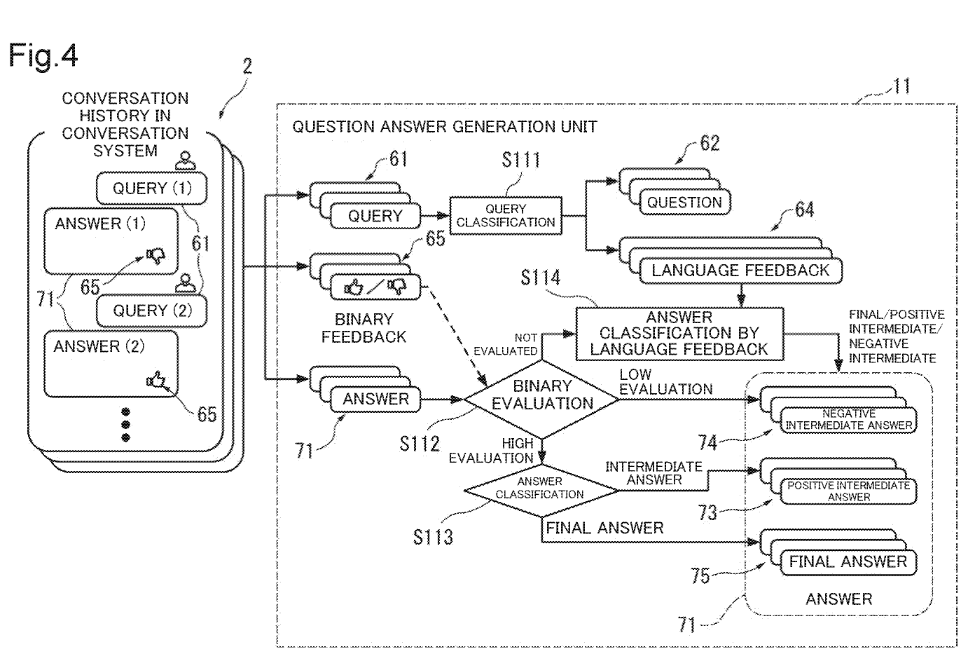

Next, generation of the question 62 and the answer 71 by the question answer generation unit 11 will be described with reference to FIG. 3. The question answer generation unit 11 generates a question 62 that is data representing a question, a final answer 75 that is data representing a final answer to the question, and an intermediate answer 72 that is data representing an intermediate answer including information included in the answer 71 output before the final answer 75 is output, based on the conversation history 2 that is data representing a history of conversation. The question 62, the final answer 75, and the intermediate answer 72 (negative intermediate answer 74) generated by the question answer generation unit 11 are data included in the task learning training data 32 (the inference ability learning training data 321 or the correction ability learning training data 322) described with reference to FIG. 4. In the present example embodiment, the question answer generation unit 11 generates one piece of training data (data including input and output of the trained model 5) from the conversation history 2 including one or more exchanges from one question to one final answer between the user and the conversation system 30. In the present example embodiment, the question answer generation unit 11 uses, for training data generation, the binary feedback 65 (high evaluation/low evaluation) or the language feedback 64 (for example, the query (2) in FIG. 4) of the user for the response (answer 71) of the conversation system 30.

As illustrated in FIG. 4, the question answer generation unit 11 first extracts the query 61, the binary feedback 65, and the answer 71 from the conversation history 2. Next, the question answer generation unit 11 classifies the query 61 into the question 62 or the language feedback 64 (query classification (S111)). The classification processing in the query classification (S111) may be, for example, rule-based classification processing or classification processing using a trained model.

The question answer generation unit 11 generates a positive intermediate answer 73, a negative intermediate answer 74, or a final answer 75 from the answer 71. First, based on the binary feedback 65, in a case where the binary feedback 65 has low evaluation (S112: low evaluation), the question answer generation unit 11 generates a negative intermediate answer 74 based on the answer 71.

In a case where the binary feedback 65 is highly evaluated (S112: high evaluation), the question answer generation unit 11 classifies the highly evaluated answer 71 into the final answer or the intermediate answer by using the rule base or the trained model (S113), and generates the final answer 75 or the intermediate answer 73.

In a case where the binary feedback 65 is not evaluated (S112: not evaluated), the question answer generation unit 11 performs answer classification using a rule base or a trained model based on the language feedback 64 (S114), and generates the final answer 75, the positive intermediate answer 73, or the negative intermediate answer 74 based on the answer 71.

The question answer generation unit 11 may generate the question 62, the intermediate answer 72 (positive intermediate answer 73 or negative intermediate answer 74), and the final answer 75 by directly using the information included in the query 61 and the answer 71, or may generate the question 62, the intermediate answer 72 (positive intermediate answer 73 or negative intermediate answer 74), and the final answer 75 by, for example, modifying a part or all of the information included in the query 61 and the answer 71.

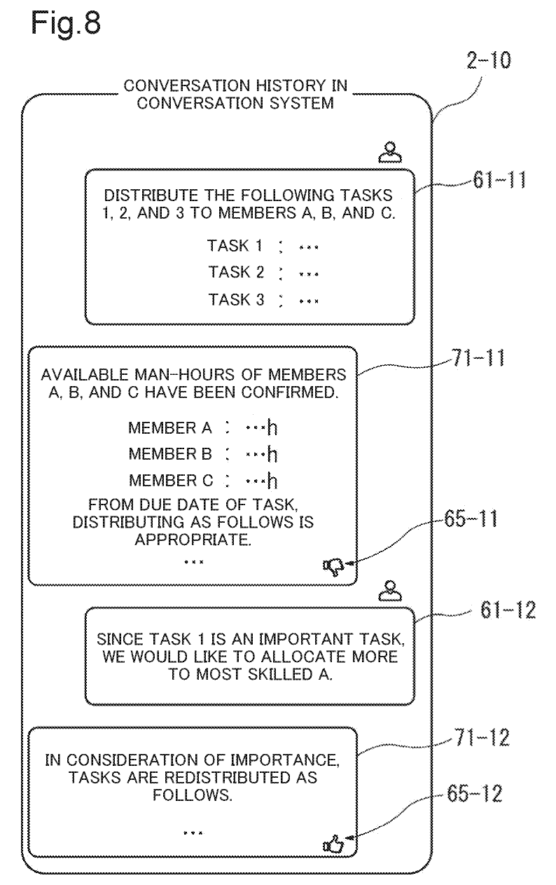

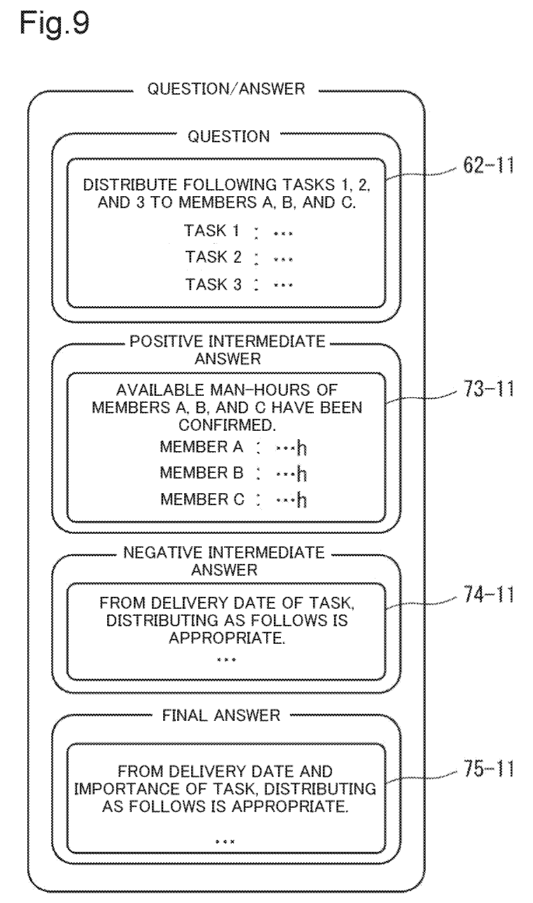

FIG. 8 illustrates an example of the conversation history 2 as a conversation history 2-10. FIG. 9 illustrates an example of a question and an answer generated by the question answer generation unit 11 based on the conversation history 2-10. The conversation history 2-10 illustrated in FIG. 8 is an example of a case where the conversation system 30 provides the user with a chatbot service that performs project management.

In the conversation history 2-10, first, the user inputs a query 61-11. The query 61-11 is “Distribute the following tasks 1, 2, and 3 to members A, B, and C. Task 1:... Task 2:... Task 3:...”, and includes a question of obtaining a solution (optimal solution) in a case where three tasks are distributed to three members (staff members). Here, “...” is any character string, and in this case, includes information indicating the content of the task.

Next, in the conversation history 2-10, the conversation system 30 outputs an answer 71-11.

The answer 71-11 is “The available man-hours of members A, B, and C have been confirmed. Member A:...h Member B:...h Member C:...h From the due date of the task, distributing as follows is appropriate....". For the answer 71-11, the user inputs the binary feedback 65-11 of low evaluation.

Next, in the conversation history 2-10, the user inputs a query 61-12. The query 61-12 is “Since task 1 is an important task, we would like to allocate more to the most skilled Member A”.

Next, in the conversation history 2-10, the conversation system 30 outputs an answer 71-12.

The answer 71-12 is “In consideration of the importance, the tasks are redistributed as follows....”. The user inputs highly evaluated binary feedback 65-12 to the answer 71-12.

Based on the conversation history 2-10 illustrated in FIG. 8, the question answer generation unit 11 generates, for example, a question 62-11, a positive intermediate answer 73-11, a negative intermediate answer 74-11, and a final answer 75-11 illustrated in FIG. 9. In the example illustrated in FIG. 9, the question 62-11 is “Distribute the following tasks 1, 2, and 3 to members A, B, and C. Task 1:... Task 2:... Task 3:...”. The positive intermediate answer 73-11 is “The available man-hours of members A, B, and C have been confirmed. Member A:...h Member B:...h Member C:...h”. The negative intermediate answer 74-11 is “From the delivery date of the task, distributing as follows is appropriate....”. The final answer 75-11 is “From the delivery date and importance of the task, distributing as follows is appropriate....”.

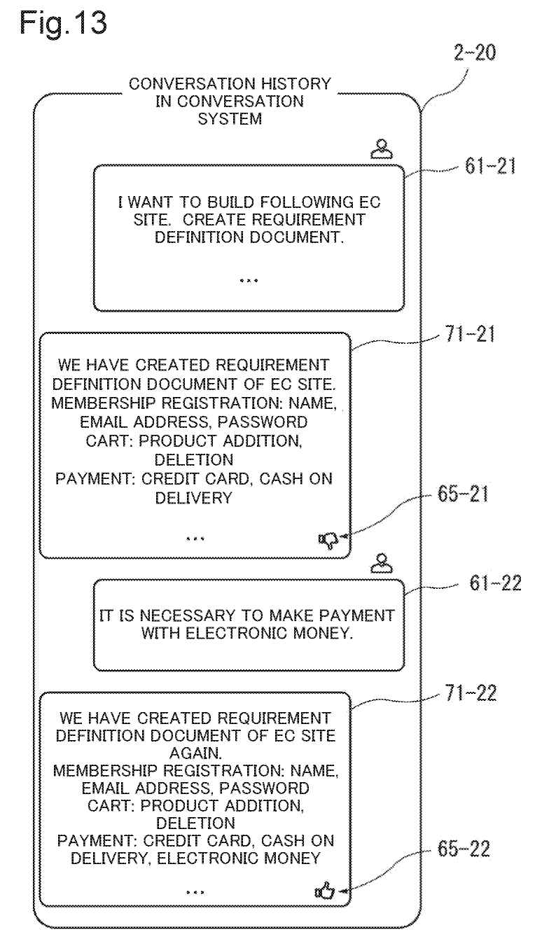

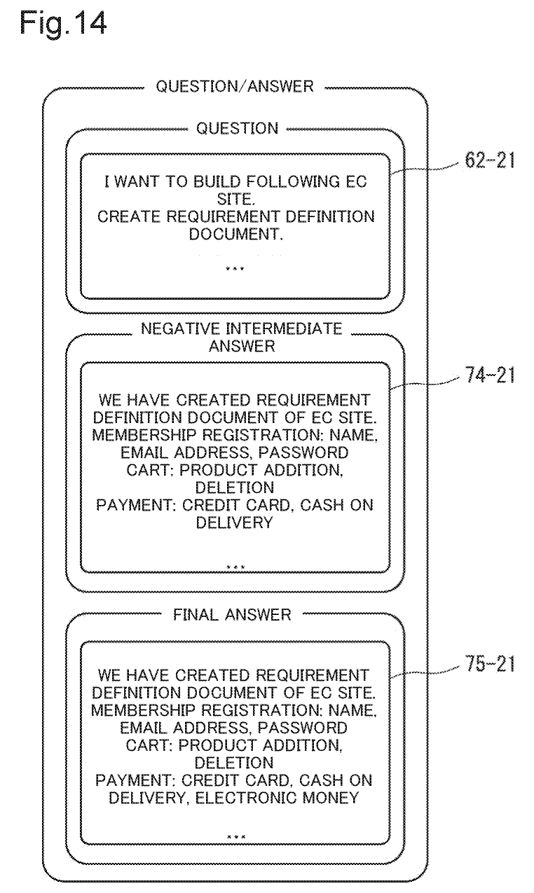

FIG. 13 illustrates an example of the conversation history 2 as a conversation history 2-20. FIG. 14 illustrates an example of a question and an answer generated by the question answer generation unit 11 based on the conversation history 2-20. The conversation history 2-20 illustrated in

FIG. 13 is an example of a case where the conversation system 30 provides the user with a chatbot service that automatically creates a requirement definition document. The requirement definition document is, for example, a document that defines functions, requirements, and the like necessary for the system to be developed.

In the conversation history 2-20, first, the user inputs a query 61-21. The query 61-21 is “I want to build the following EC site. Create a requirement definition document....”, and involves creating a requirement definition documents for building an EC (Electronic Commerce) website.

Next, in the conversation history 2-20, the conversation system 30 outputs an answer 71-21.

The answer 71-21 is “We have created a requirement definition document of the EC site. Membership registration: name, email address, password Cart: product addition, deletion Payment: credit card, cash on delivery...”. The user inputs the binary feedback 65-21 of low evaluation to the answer 71-21.

Next, in the conversation history 2-20, the user inputs a query 61-22. The query 61-22 is “It is necessary to make payment with electronic money”.

Next, in the conversation history 2-20, the conversation system 30 outputs the answer 71-22.

The answer 71-22 is “We have created the requirement definition document of the EC site again. Membership registration: name, email address, password Cart: product addition, deletion Payment: credit card, cash on delivery, electronic money...”. The user inputs highly evaluated binary feedback 65-22 to the answer 71-22.

Based on the conversation history 2-20 illustrated in FIG. 13, the question answer generation unit 11 generates, for example, a question 62-21, a negative intermediate answer 74-21, and a final answer 75-21 illustrated in FIG. 14. In the example illustrated in FIG. 14, the question 62-21 is “I want to build the following EC site. Create a requirement definition document....”. The negative intermediate answer 74-21 is “We have created a requirement definition document of the EC site. Membership registration: name, email address, password Cart: product addition, deletion Payment: credit card, cash on delivery...”. The final answer 75-21 is “We have created the requirement definition document of the EC site. Membership registration: name, email address, password Cart: product addition, deletion Payment: credit card, cash on delivery, electronic money...”.

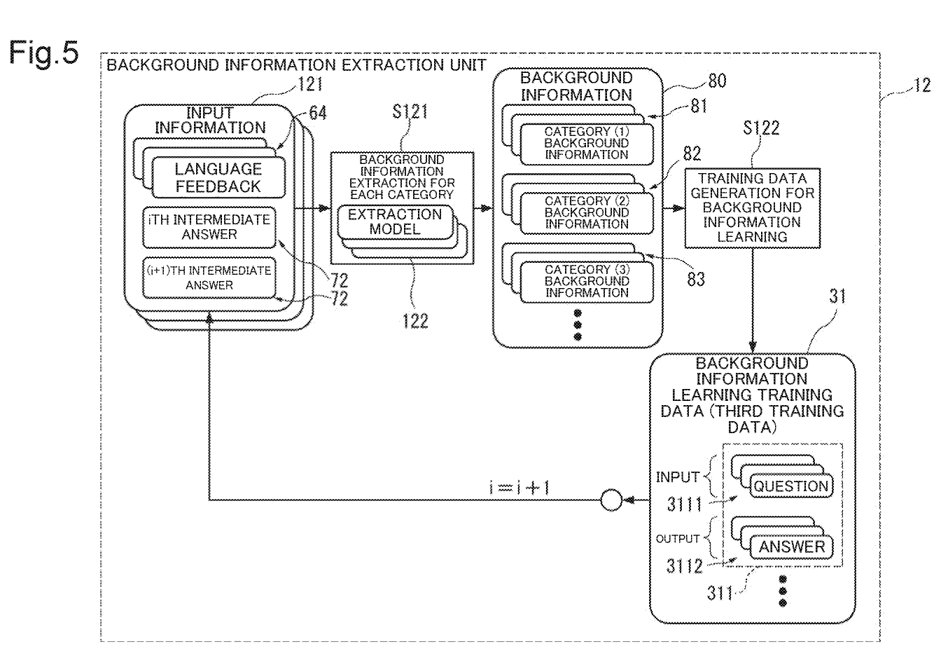

Next, extraction of background information 80 by the background information extraction unit 12 will be described with reference to FIG. 5. The background information extraction unit 12 extracts the data 80 representing background information related to the question 62 and answer 71 based on the language feedback 64 and the intermediate answer 72. The background information extraction unit 12 divides the background information 80 into the question 3111 (query) and the correct answer 3112 (response), and includes a set of the data 3111 representing the question as an input to the trained model 5 and the data 3112 representing the correct answer as an output from the trained model 5 in the training data 3 as the background information learning training data 31.

The background information extraction unit 12 inputs input information 121 and outputs the background information 80 for each category using an extraction model 122 that is a trained model (background information extraction S121 for each category). In the background information extraction S121 for each category, the extraction model 122 generated for each category is used. The category is language knowledge, domain knowledge, user specific knowledge, or the like. In the present example embodiment, the background information extraction unit 12 extracts, from the input information 121, the background information 80 necessary for inference from the ith intermediate answer 72 to the (i + 1)th intermediate answer 72 included in the conversation history 2. The input information 121 includes a language feedback 64 related to the (i + 1)th intermediate answer 72 from the ith intermediate answer 72, the ith intermediate answer 72, and the (i + 1)th intermediate answer 72. The extraction model 122 analyzes the input information 121 while shifting the steps (while i = i + 1) based on the language feedback 64 for each step from the intermediate answer 72 to the next intermediate answer 72. In the example illustrated in FIG. 5, the background information extraction unit 12 extracts the background information 81 to 83 suitable for each category, and converts the background information into the training data 311 for each category including a pair of the question 3111 and the correct answer 3112 (training data generation S122 for background information learning).

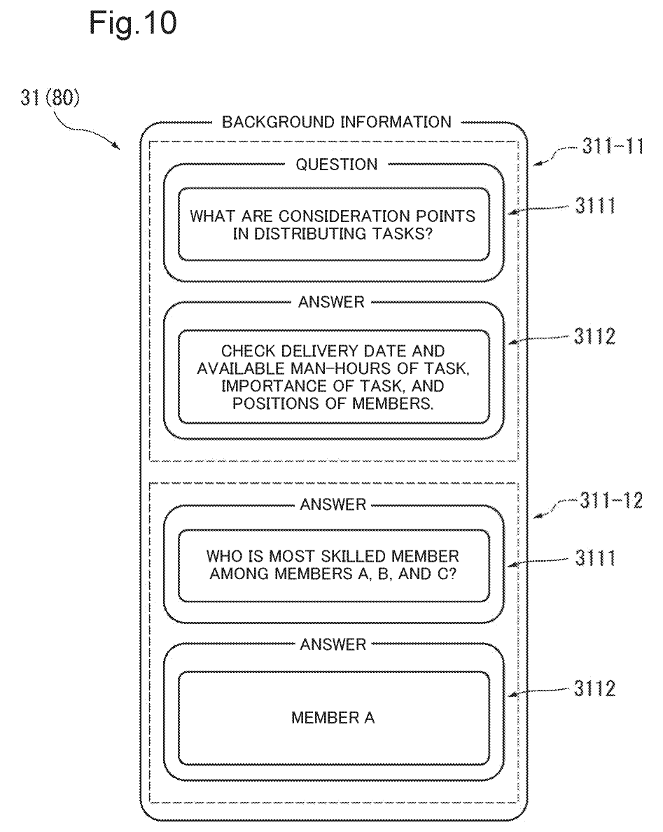

FIG. 10 illustrates an example of the background information learning training data 31 including training data 311-11 and training data 311-12 extracted from the background information 80 extracted based on the example of the conversation history 2-10 illustrated in FIG. 8 and the question and the answer illustrated in FIG. 9. In the example illustrated in FIG. 10, the question 3111 included in the training data 311-11 is “what are consideration points in distributing tasks?”. The correct answer 3112 included in the training data 311-11 is “Check the delivery date and available man-hours of the task, the importance of the task, and the positions of members”. In this case, the background information 80 of the extraction source of the training data 311-12 is, for example, “Consideration points in distributing tasks are to check the delivery date and available man-hours of the task, the importance of the task, and the positions of members”. The question 3111 included in the training data 311-12 is “Who is the most skilled member among the members A, B, and C?”. The correct answer 3112 included in the training data 311-12 is “member A”. In this case, the background information 80 of the extraction source of the training data 311-11 is, for example, “Among the members A, B, and C, the most skilled member is the member A”.

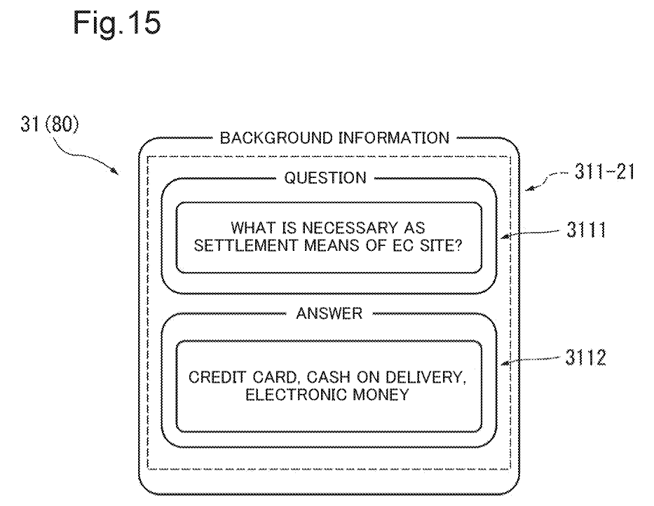

FIG. 15 illustrates an example of the background information learning training data 31 including training data 311-21 extracted from the background information 80 extracted based on the example of the conversation history 2-20 illustrated in FIG. 13 and the question and the answer illustrated in FIG. 14. In the example illustrated in FIG. 15, the question 3111 included in the training data 311-21 is “What is necessary as a settlement means of an EC site?”. The correct answer 3112 included in the training data 311-21 is “credit card, cash on delivery, electronic money”. In this case, the background information 80 of the extraction source of the training data 311-21 is, for example, “Credit card, cash on delivery, and electronic money are required as settlement means of the EC site”.

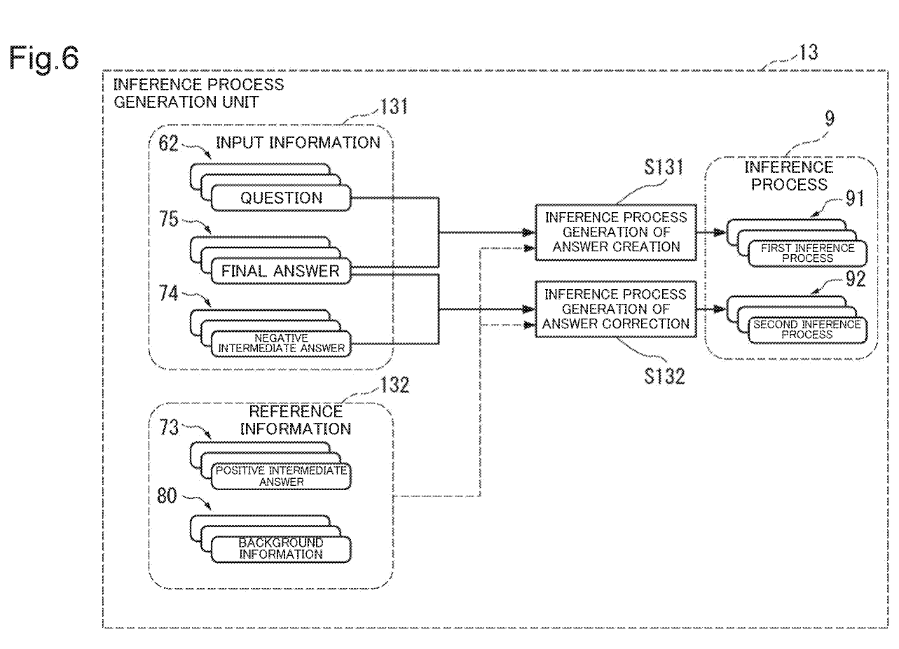

Next, generation of the first inference process 91 and the second inference process 92 by the inference process generation unit 13 will be described with reference to FIG. 6. The inference process generation unit 13 refers to the intermediate answer 72 (positive intermediate answer 73) or refers to the positive intermediate answer 73 and the background information 80, and generates data 91 (inference process 9) representing the first inference process from the question 62 to the final answer 75 based on the question 62 and the final answer 75 (inference process generation S131 of answer creation). The inference process generation unit 13 generates data 92 representing the second inference process from the negative intermediate answer 74 to the final answer 75 based on the negative intermediate answer 74 and the final answer 75 (inference process generation S132 of answer correction) in addition to referring to the intermediate answer 72 (positive intermediate answer 73) or the positive intermediate answer 73 and the background information 80, and generating data 91 representing the first inference process based on the question 62 and the final answer 75 (inference process generation S131 of answer creation) In the example illustrated in FIG. 6, the input information 131 includes the question 62, the final answer 75, and the negative intermediate answer 74. Reference information 132 includes the positive intermediate answer 73 and the background information 80.

The inference process generation S131 for answer creation can be performed using, for example, a trained model. In this case, the trained model is machine-learned to input the input information 131 (the question 62 and the final answer 75) and the reference information (the positive intermediate answer 73 and the background information 80) and output the first inference process 91.

The inference process generation S132 of the answer correction can be performed using, for example, a trained model. In this case, the trained model is machine-learned to input the input information 131 (the negative intermediate answer 74 and the final answer 75) and the reference information (the positive intermediate answer 73 and the background information 80) and output the second inference process 92.

The first inference process 91 and the second inference process 92 generated by the inference process generation unit 13 are data included in the task learning training data 32 (the inference ability learning training data 321 or the correction ability learning training data 322) described with reference to FIG. 4, for example, in a case where the inference process evaluation unit 14 evaluates that the reliability is high or in a case where the inference process evaluation unit 14 evaluates that the reliability is low and the first inference process and the second inference process are corrected by the inference process correction unit 15. In the present example embodiment, the inference process 9 is generated with reference to the intermediate answer 72 (positive intermediate answer 73) and the background information 80, and the machine learning is performed using the training data 3 including the inference process 9, so that the trained model 5 can accurately generate the final answer 75 even when the logic from the question 62 to the final answer 75 is complicated.

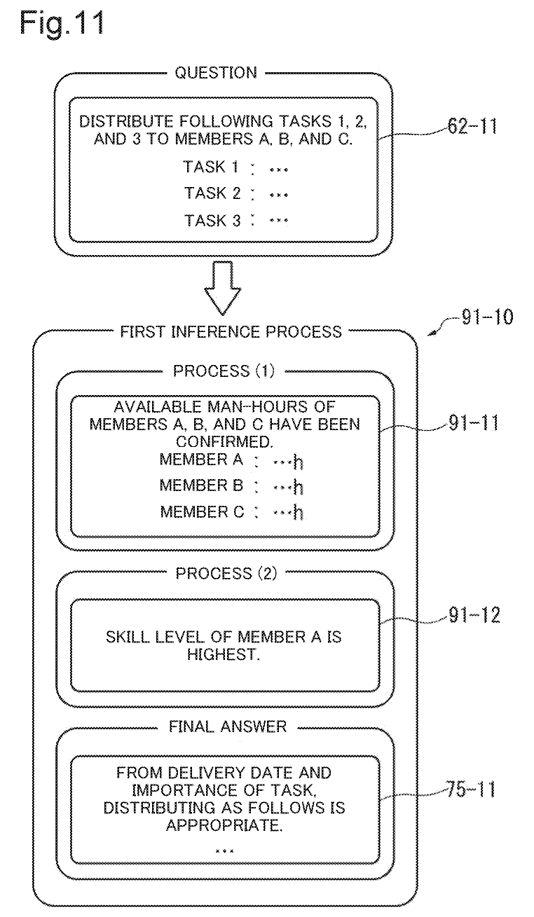

FIG. 11 illustrates an example of a first inference process 91-10 generated based on the conversation history 2-10 illustrated in FIG. 8, the example of the question and the answer illustrated in FIG. 9, and the example of the background information described with reference to FIG. 10. The first inference process 91-10 is an inference process from the question 62-11 (FIG. 9) to the final answer 75-11 (FIG. 9). The first inference process 91-10 includes data associated with the question 62-11 and the final answer 75-11. The first inference process 91-10 includes a process (1) 91-11, a process (2) 91-12, and the final answer 75-11. However, the final answer 75-11 may be omitted. In the example illustrated in FIG. 11, the process (1) 91-11 is “The available man-hours of members A, B, and C have been confirmed. Member A:...h Member B:...h Member C:...h”. The process (2) 91-12 is “The skill level of member A is the highest”.

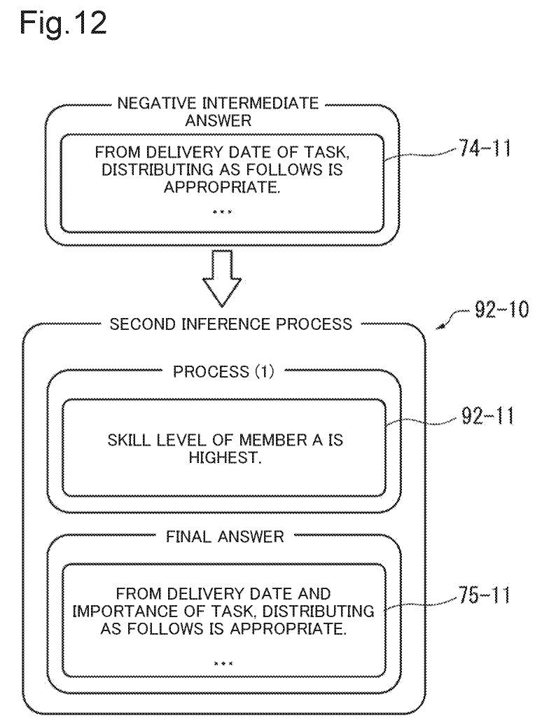

FIG. 12 illustrates an example of a second inference process 92-10 generated based on the conversation history 2-10 illustrated in FIG. 8, the example of the question and the answer illustrated in FIG. 9, and the example of the background information described with reference to FIG. 10. The second inference process 92-10 is an inference process from the negative intermediate answer 74-11 (FIG. 9) to the final answer 75-11 (FIG. 9). The second inference process 92-10 includes data associated with the negative intermediate answer 74-11 and the final answer 75-11. The second inference process 92-10 includes a process (1) 92-11 and the final answer 75-11. However, the final answer 75-11 may be omitted. In the example illustrated in FIG. 12, the process (1) 92-11 is “The skill level of member A is the highest”.

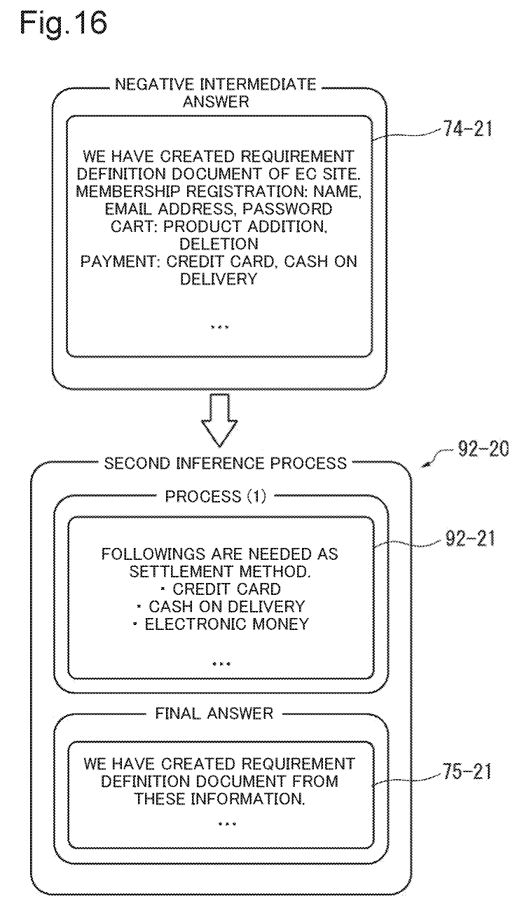

FIG. 16 illustrates an example of a second inference process 92-20 generated based on the conversation history 2-20 illustrated in FIG. 13, the example of the question and the answer illustrated in FIG. 14, and the example of the background information described with reference to FIG. 15. The second inference process 92-20 is an inference process from the negative intermediate answer 74-21 (FIG. 14) to the final answer 75-21 (FIG. 14). The second inference process 92-20 includes data associated with the negative intermediate answer 74-21 and the final answer 75-21. The second inference process 92-20 includes a process (1) 92-21 and the final answer 75-21. However, the final answer 75-21 may be omitted. In the example illustrated in FIG. 16, the process (1) 92-21 is “It is necessary to implement the following as a settlement method. ∙Credit card ∙Cash on delivery ∙Electronic money...”.

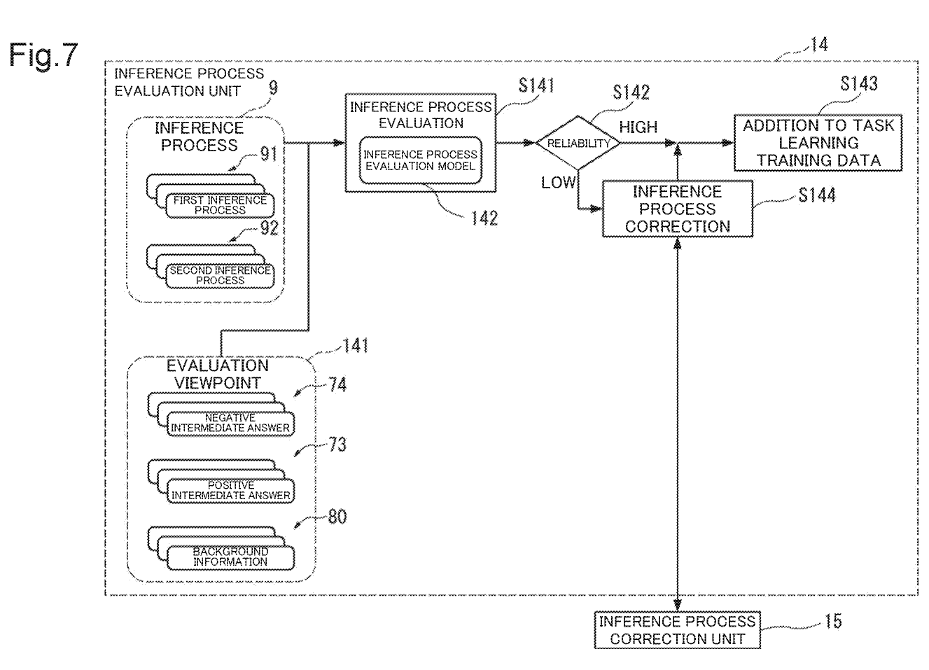

Next, the inference process evaluation unit 14 and the inference process correction unit 15 will be described with reference to FIG. 7. The inference process evaluation unit 14 evaluates an inference process 9 by comparing the inference process 9 with at least one of the positive intermediate answer 73, the negative intermediate answer 74, and the background information 80. For example, the inference process evaluation unit 14 evaluates the inference process by using an inference process evaluation model 142 that is a trained model that inputs the inference process 9 and at least one of the negative intermediate answer 74, the positive intermediate answer 73, and the background information 80 and outputs the reliability of the inference process 9 (S141).

The inference process evaluation model 142 is machine-learned so as to output data indicating the reliability with the inference process 9 and at least one of the negative intermediate answer 74, the positive intermediate answer 73, and the background information 80 as input data. The reliability can be calculated, for example, by comparing the inference process 9 with the positive intermediate answer 73, and in a case where the inference process 9 includes the answers 71 relevant (associated) to all the positive intermediate answers 73, the reliability is highly evaluated, and in a case where the inference process 9 does not include all the answers, the reliability is lowered according to the included ratio. Alternatively, the reliability can be calculated, for example, by comparing the inference process 9 with the negative intermediate answer 74, such that the reliability is lowered in a case where a proportion of the answer 71 relevant (associated) to the negative intermediate answer 74 in the inference process 9 is high, and the reliability is raised in a case where the proportion is low. Alternatively, the reliability can be calculated, for example, by comparing the inference process 9 with the background information 80, such that the reliability is lowered in a case where the answer 71 against the background information 80 is included in the inference process 9, and the reliability is raised in a case where the answer 71 against the background information 80 is not included. The reliability can be calculated, for example, by combining these calculation methods. The training data used for the machine learning of the inference process evaluation model 142 can be generated using, for example, a result of calculating the reliability on a rule basis.

In the example illustrated in FIG. 7, the evaluation target is the inference process 9, and the negative intermediate answer 74, the positive intermediate answer 73, and the background information 80 are the evaluation viewpoints 141. The inference process evaluation unit 14 calculates the reliability indicating the degree of evaluation based on the result of comparison between the inference process 9 and the evaluation viewpoint 141, and determines that the inference process needs to be corrected in a case where the reliability does not satisfy a predetermined criterion (S142).

Then, in a case where the inference process correction unit 15 determines that the inference process needs to be corrected (S142: low), the inference process correction unit 15 displays data representing the inference process in a natural language, and for example, the inference process evaluation unit 14 corrects the data 9 representing the inference process based on the input instruction (S144). For example, the inference process correction unit 15 corrects the inference process 9 and the background information 80 or adds the background information 80 as necessary.

The inference process evaluation unit 14 adds the inference process 9 determined to have a high reliability and the inference process 9 corrected in the inference process correction S144 to the task learning training data 32 (FIG. 3) (S143).

As described above, the generation device 1 of the present example embodiment is a device that simulates a conversation with a user in a natural language, inputs the data 62 representing a question issued from the user and the data 63 representing feedback from the user, and generates the training data 3 for fine-tuning of the trained model 5 that generates and outputs the data 71 representing an answer to the question. The generation device 1 includes a question answer generation unit 11 and an inference process generation unit 13. The question answer generation unit 11 generates data 62 representing a question, data 75 representing a final answer that is a final answer 71 to the question, and data 72 representing an intermediate answer including information included in the answer 71 output before the final answer is output, based on the data 2 representing the conversation history. The inference process generation unit 13 refers to the intermediate answer and generates data 9 (first inference process 91) representing the inference process from the question to the final answer based on the question and the final answer. Then, the training data 3 includes a plurality of sets of data 62 representing a question as an input to the trained model 5, data 75 representing a final answer as an output from the trained model 5, and data 9 representing an inference process (first inference process 91) as the inference ability learning training data 321 (first training data). According to this configuration, since each data included in the training data can be automatically generated, it is easy to generate the training data.

In the generation device 1 of the present example embodiment, the intermediate answer 72 includes a positive intermediate answer 73 that is a correct answer included in the conversation until the final answer is output and a negative intermediate answer 74 that is an incorrect answer included in the conversation until the final answer is output. The inference process 9 includes a first inference process 91 from the question 62 to the final answer 75 and a second inference process 92 from the negative intermediate answer 74 to the final answer 75. The inference process generation unit 13 refers to the positive intermediate answer 73, generates data 91 representing the first inference process based on the question 62 and the final answer 75, and generates data 92 representing the second inference process based on the negative intermediate answer 74 and the final answer 75. The training data 3 includes a plurality of sets of data 62 representing a question as an input to the trained model 5, data 75 representing a final answer as an output from the trained model 5, and data 91 representing a first inference process as the inference ability learning training data 321 (first training data). The training data 3 includes a plurality of sets of data 74 representing a negative intermediate answer as an input to the trained model 5, data 75 representing a final answer as an output from the trained model 5, and data 92 representing a second inference process as the correction ability learning training data 322 (second training data). According to this configuration, by using the inference process 9 as the output of the training data 3, it is possible to learn the inference ability for a complicated question. It is possible to learn the correction ability by setting the output of a correct final answer from an erroneous answer as training data. By using the intermediate answer for the inference process generation, the difficulty level of the inference process generation can be reduced, and accurate training data can be generated even for a complicated question.

The generation device 1 of the present example embodiment includes the background information extraction unit 12 that extracts the data 80 representing the background information related to the question and the answer based on the positive intermediate answer 73 and the feedback by language (language feedback 64). Then, the inference process generation unit 13 generates data 91 representing the first inference process and data 92 representing the second inference process with reference to the positive intermediate answer 73 and the background information 80. According to this configuration, by generating the inference process with reference to the intermediate answer and the background information, the inference process can be accurately generated even in a case where the logic from the question to the final answer is complicated.

The background information extraction unit 12 separates the background information into the inquiry and the response, and includes a set of data representing the inquiry as an input to the trained model 5 and data representing the response as an output from the trained model 5 in the training data 3 as the background information learning training data 31 (third training data). According to this configuration, basic knowledge can be trained by using the background information for model learning.

The inference process evaluation unit 14 evaluates the inference process by comparing the inference process 9 with at least one of the positive intermediate answer 73, the negative intermediate answer 74, and the background information 80. According to this configuration, the inference process 9 can be evaluated based on the comparison result with at least one of the positive intermediate answer 73, the negative intermediate answer 74, and the background information 80.

The inference process evaluation unit 14 calculates the reliability indicating the degree of evaluation based on the comparison result, and determines that the inference process needs to be corrected in a case where the reliability does not satisfy a predetermined criterion. Then, in a case where the inference process evaluation unit 14 determines that the inference process needs to be corrected, the inference process correction unit 15 displays data representing the inference process in a natural language, and corrects the data representing the inference process based on the input instruction. According to this configuration, the inference process is evaluated, and in a case where the evaluation is low, the inference process can be corrected. For example, by automatically evaluating the reliability of the generated inference process, it is possible to ensure the quality of training data while minimizing human annotations in training data generation.

The feedback 63 includes a language feedback 64 that is a language feedback and a binary feedback 65 that is a feedback representing the degree of evaluation as either of a binary value. According to this configuration, the feedback 63 can have a plurality of modes.

The trained model 5 is fine-tuned with the background information learning training data 31 (third training data), and then fine-tuned with the inference ability learning training data 321 (first training data) and the correction ability learning training data 322 (second training data). According to this configuration, by using the background information for model learning, learning can be stabilized by learning in stages from basic knowledge to a complicated task, and the ability of the model can be efficiently improved.

### Second Example Embodiment

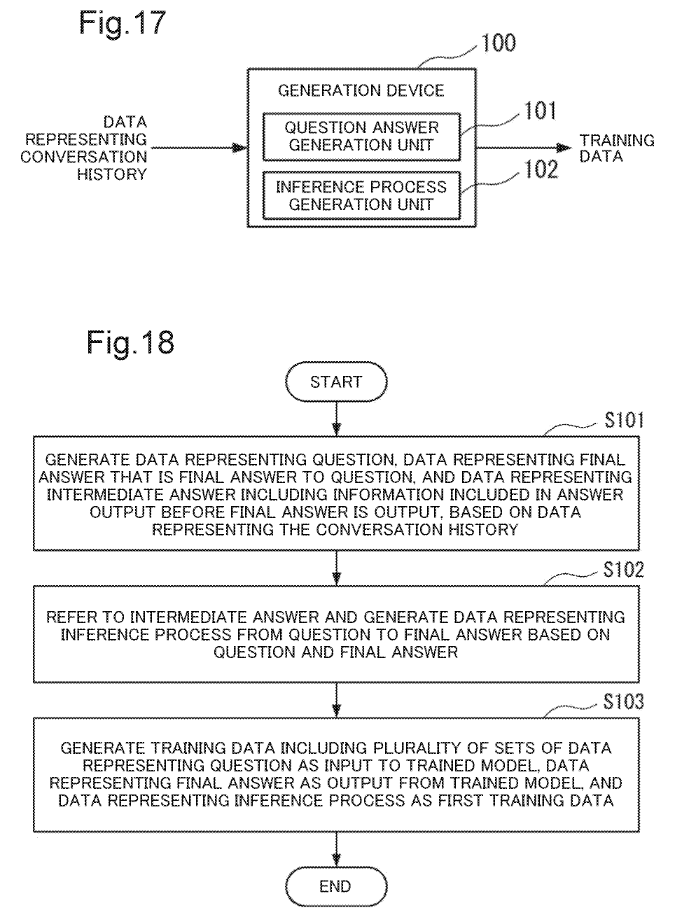

Hereinafter, one example embodiment according to the present disclosure will be described with reference to the drawings. FIG. 17 is a configuration diagram of a generation device 100 according to the present disclosure. The generation device 100 illustrated in FIG. 17 includes a question answer generation unit 101 and an inference process generation unit 102. The generation device 100 is a device that simulates a conversation with a user in a natural language, inputs the data representing a question issued from the user and the data representing feedback from the user, and generates the training data for fine-tuning of the trained model that generates and outputs the data representing an answer to the question. The question answer generation unit 101 generates data representing a question, data representing a final answer that is a final answer to the question, and data representing an intermediate answer including information included in the answer output before the final answer is output, based on the data representing the conversation history. The inference process generation unit 102 refers to the intermediate answer and generates data representing the inference process from the question to the final answer based on the question and the final answer. The training data includes a plurality of sets of data representing a question as an input to the trained model, data representing a final answer as an output from the trained model, and data representing the inference process as the first training data. According to this configuration, since each data included in the training data can be automatically generated, it is easy to generate the training data.

### Third Example Embodiment

Hereinafter, one example embodiment according to the present disclosure will be described with reference to the drawings. FIG. 18 is a flowchart illustrating an operation example of the generation method according to the present disclosure. This generation method simulates a conversation with a user in a natural language, inputs the data representing a question issued from the user and the data representing feedback from the user, and generates the training data for fine-tuning of the trained model that generates and outputs the data representing an answer to the question. The processing (generation method) illustrated in FIG. 18 includes step S101 of generating data representing a question, data representing a final answer that is a final answer to the question, and data representing an intermediate answer including information included in the answer output before the final answer is output, based on the data representing the conversation history. The method also includes step S102 of referring to the intermediate answer and generating data representing the inference process from the question to the final answer based on the question and the final answer. The processing (generation method) illustrated in FIG. 18 includes step S103 of generating training data including a plurality of sets of data representing a question as an input to the trained model, data representing a final answer as an output from the trained model, and data representing the inference process as the first training data. According to this processing (generation method), since each data included in the training data can be automatically generated, it is easy to generate the training data.

### Computer Configuration

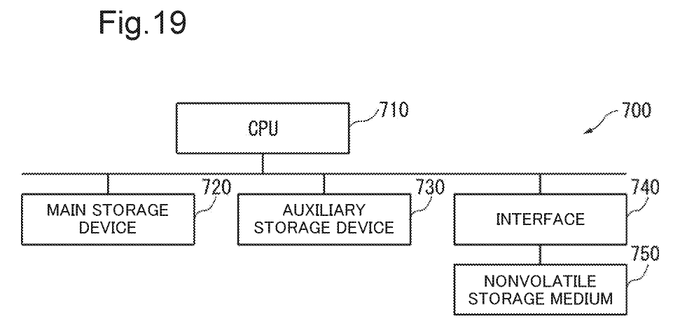

FIG. 19 is a block diagram illustrating a schematic configuration example of a computer according to an example embodiment of the present disclosure. A computer 700 includes a central processing unit (CPU) 710, a main storage device 720, an auxiliary storage device 730, and an interface 740. For example, a nonvolatile storage medium 750 is connected to the interface 740. The above-described generation device 1 and the like are mounted on the computer 700. Then, the operation of each processing unit (functional block) described above is stored in the auxiliary storage device 730 in the form of a program. The CPU 710 reads the program from the auxiliary storage device 730, loads the program in the main storage device 720, and executes the above processing according to the program. The CPU 710 secures a storage area related to each of the above-described storage units in the main storage device 720 according to the program.

The program may be for implementing a part of the functions to be exerted by the computer 700. For example, the program may exhibit a function by a combination with another program already stored in the auxiliary storage device 730 or a combination with another program mounted on another device. In another example embodiment, the computer may include a custom large scale integrated circuit (LSI) such as a programmable logic device (PLD) in addition to or instead of the above configuration. Examples of the PLD include a PAL (Programmable Array Logic), a GAL (Generic Array Logic), a CPLD (Complex Programmable Logic Device), and an FPGA (Field Programmable Gate Array). In this case, some or all of the functions implemented by the CPU 710 may be implemented by the integrated circuit.

Examples of the auxiliary storage device 730 include a hard disk drive (HDD) or a solid state drive (SSD), a magnetic disk, a magneto-optical disk, a compact disc read only memory (CD-ROM), a digital versatile disc read only memory (DVD-ROM), a semiconductor memory, and the like. The auxiliary storage device 730 may be an internal medium directly connected to a bus of the computer 700, or may be an external medium connected to the computer 700 via the interface 740 or a communication line. In a case where this program is distributed to the computer 700 via a communication line, the computer 700 that has received the distribution may expand the program in the main storage device 720 and execute the above processing. In at least one example embodiment, the auxiliary storage device 730 is a non-transitory tangible storage medium.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments. For example, the conversation system 30 may provide a conversation service by text input/output, or may provide a conversation service by voice input/output.

In the information processing device described in JP 2022-145124 A, it is necessary for a user or the like to prepare a part of the training data in advance. For this reason, for example, in a case where it is difficult to prepare training data, there is a problem that it may be difficult to generate learning data.

According to the above aspect, training data is easily generated. Some or all of the above example embodiments may be described as the following supplementary notes, but are not limited to the following.

### Supplementary Note 1

A generation device for generating training data for fine-tuning of a trained model that simulates a conversation with a user in a natural language, inputs data representing a question issued from the user and data representing feedback from the user, and generates and outputs data representing an answer to the question, the device including:

a question answer generation unit that generates, based on data representing a history of the conversation, data representing the question, data representing a final answer that is a final answer to the question, and data representing an intermediate answer including information included in the answer output before outputting the final answer; and

an inference process generation unit that refers to the intermediate answer and generates data representing an inference process from the question to the final answer based on the question and the final answer,

in which the training data includes, as first training data, a plurality of sets of data representing the question as an input to the trained model, data representing the final answer as an output from the trained model, and data representing the inference process.

### Supplementary Note 2

The generation device according to Supplementary Note 1, in which

the intermediate answer includes a positive intermediate answer that is the correct answer included in the conversation until outputting the final answer and a negative intermediate answer that is the incorrect answer included in the conversation until outputting the final answer,

the inference process includes a first inference process from the question to the final answer and a second inference process from the negative intermediate answer to the final answer,

the inference process generation unit refers to the positive intermediate answer, generates data representing the first inference process based on the question and the final answer, and generates data representing the second inference process based on the negative intermediate answer and the final answer, and

the training data includes, as the first training data, a plurality of sets of data representing the question as an input to the trained model, data representing the final answer as an output from the trained model, and data representing the first inference process, and includes, as second training data, a plurality of sets of data representing the negative intermediate answer as an input to the trained model, data representing the final answer as an output from the trained model, and data representing the second inference process.

### Supplementary Note 3

The generation device according to Supplementary Note 1 or 2, including a background information extraction unit that extracts data representing background information related to the question and the answer based on the intermediate answer and the feedback in language,

in which the inference process generation unit generates data representing the first inference process and data representing the second inference process with reference to the positive intermediate answer and the background information.

### Supplementary Note 4

The generation device according to any one of Supplementary Notes 1 to 3, in which the background information extraction unit separates the background information into an inquiry and a response, and includes, in the training data, a set of data representing the inquiry as an input to the trained model and data representing the response as an output from the trained model as third training data.

### Supplementary Note 5

The generation device according to any one of Supplementary Notes 1 to 4, further including an inference process evaluation unit that evaluates the inference process by comparing the inference process with at least one of the positive intermediate answer, the negative intermediate answer, and the background information.

### Supplementary Note 6

The generation device according to any one of Supplementary Notes 1 to 5, in which

the inference process evaluation unit calculates reliability indicating a degree of the evaluation based on a result of the comparison, and determines that the inference process needs to be corrected in a case where the reliability does not satisfy a predetermined criterion, and

the generation device further includes an inference process correction unit that, in a case where the inference process evaluation unit determines that the inference process needs to be corrected, displays data representing the inference process in a natural language and corrects the data representing the inference process based on an input instruction.

### Supplementary Note 7

The generation device according to any one of Supplementary Notes 1 to 6, in which the feedback includes a language feedback that is the feedback by language and a binary feedback that is the feedback representing a degree of evaluation as either of a binary value.

### Supplementary Note 8

The generation device according to any one of Supplementary Notes 1 to 7, in which the trained model is fine-tuned with the first training data and the second training data after being fine-tuned with the third training data.

### Supplementary Note 9

A generation method for generating training data for fine-tuning of a trained model that simulates a conversation with a user in a natural language, inputs data representing a question issued from the user and data representing feedback from the user, and generates and outputs data representing an answer to the question, the method including:

a step of generating, based on data representing a history of the conversation, data representing the question, data representing a final answer that is a final answer to the question, and data representing an intermediate answer including information included in the answer output before outputting the final answer;

a step of referring to the intermediate answer and generating data representing an inference process from the question to the final answer based on the question and the final answer; and

a step of generating the training data including, as first training data, a plurality of sets of data representing the question as an input to the trained model, data representing the final answer as an output from the trained model, and data representing the inference process.

### Supplementary Note 10

The generation method according to Supplementary Note 9, in which

the intermediate answer includes a positive intermediate answer that is the correct answer included in the conversation until outputting the final answer and a negative intermediate answer that is the incorrect answer included in the conversation until outputting the final answer,

the inference process includes a first inference process from the question to the final answer and a second inference process from the negative intermediate answer to the final answer,

in the step of generating data representing the inference process, the positive intermediate answer is referred to, data representing the first inference process is generated based on the question and the final answer, and data representing the second inference process is generated based on the negative intermediate answer and the final answer, and

the training data includes, as the first training data, a plurality of sets of data representing the question as an input to the trained model, data representing the final answer as an output from the trained model, and data representing the first inference process, and includes, as second training data, a plurality of sets of data representing the negative intermediate answer as an input to the trained model, data representing the final answer as an output from the trained model, and data representing the second inference process.

### Supplementary Note 11

The generation method according to Supplementary Note 9 or 10, including a step of extracting data representing background information related to the question and the answer based on the intermediate answer and the feedback in language,

in which in the step of generating data representing the inference process, data representing the first inference process and data representing the second inference process are generated with reference to the positive intermediate answer and the background information.

### Supplementary Note 12

The generation method according to any one of Supplementary Notes 9 to 11, in which in the step of extracting data representing the background information, the background information is separated into an inquiry and a response, and a set of data representing the inquiry as an input to the trained model and data representing the response as an output from the trained model as third training data is included in the training data.

### Supplementary Note 13

The generation method according to any one of Supplementary Notes 9 to 12, further including a step of evaluating the inference process by comparing the inference process with at least one of the positive intermediate answer, the negative intermediate answer, and the background information.

### Supplementary Note 14

The generation method according to any one of Supplementary Notes 9 to 13, in which

in the step of evaluating the inference process, reliability indicating a degree of the evaluation is calculated based on a result of the comparison, and the inference process is determined as to need to be corrected in a case where the reliability does not satisfy a predetermined criterion, and

the generation method further includes a step of displaying, in a case where it is determined that the inference process needs to be corrected, data representing the inference process in a natural language and correcting the data representing the inference process based on an input instruction.

### Supplementary Note 15

The generation method according to any one of Supplementary Notes 9 to 14, in which the feedback includes a language feedback that is the feedback by language and a binary feedback that is the feedback representing a degree of evaluation as either of a binary value.

### Supplementary Note 16

The generation method according to any one of Supplementary Notes 9 to 15, in which the trained model is fine-tuned with the first training data and the second training data after being fine-tuned with the third training data.

### Supplementary Note 17

A non-transitory recording medium recording a program for generating training data for fine-tuning of a trained model that simulates a conversation with a user in a natural language, inputs data representing a question issued from the user and data representing feedback from the user, generates and outputs data representing an answer to the question, the program causing the computer to execute:

a step of generating, based on data representing a history of the conversation, data representing the question, data representing a final answer that is a final answer to the question, and data representing an intermediate answer including information included in the answer output before outputting the final answer;

a step of referring to the intermediate answer and generating data representing an inference process from the question to the final answer based on the question and the final answer; and

a step of generating the training data including, as first training data, a plurality of sets of data representing the question as an input to the trained model, data representing the final answer as an output from the trained model, and data representing the inference process.

### Supplementary Note 18

The non-transitory recording medium recording a program according to Supplementary Note 17, in which

the intermediate answer includes a positive intermediate answer that is the correct answer included in the conversation until outputting the final answer and a negative intermediate answer that is the incorrect answer included in the conversation until outputting the final answer,

the inference process includes a first inference process from the question to the final answer and a second inference process from the negative intermediate answer to the final answer,

in the step of generating data representing the inference process, the positive intermediate answer is referred to, data representing the first inference process is generated based on the question and the final answer, and data representing the second inference process is generated based on the negative intermediate answer and the final answer, and

the training data includes, as the first training data, a plurality of sets of data representing the question as an input to the trained model, data representing the final answer as an output from the trained model, and data representing the first inference process, and includes, as second training data, a plurality of sets of data representing the negative intermediate answer as an input to the trained model, data representing the final answer as an output from the trained model, and data representing the second inference process.

### Supplementary Note 19

The non-transitory recording medium recording a program according to Supplementary Note 17 or 18, the program including a step of extracting data representing background information related to the question and the answer based on the intermediate answer and the feedback in language,

in which in the step of generating data representing the inference process, data representing the first inference process and data representing the second inference process are generated with reference to the positive intermediate answer and the background information.

### Supplementary Note 20

The non-transitory recording medium recording a program according to any one of Supplementary Notes 17 to 19, in which in the step of extracting data representing the background information, the background information is separated into an inquiry and a response, and a set of data representing the inquiry as an input to the trained model and

data representing the response as an output from the trained model as third training data is included in the training data.

### Supplementary Note 21

The non-transitory recording medium recording a program according to any one of Supplementary Notes 17 to 20, in which the computer is caused to further execute a step of evaluating the inference process by comparing the inference process with at least one of the positive intermediate answer, the negative intermediate answer, and the background information.

### Supplementary Note 22

The non-transitory recording medium recording a program according to any one of Supplementary Notes 17 to 21, in which

in the step of evaluating the inference process, reliability indicating a degree of the evaluation is calculated based on a result of the comparison, and the inference process is determined as to need to be corrected in a case where the reliability does not satisfy a predetermined criterion, and

the computer is caused to further execute a step of displaying, in a case where it is determined that the inference process needs to be corrected, data representing the inference process in a natural language and correcting the data representing the inference process based on an input instruction.

### Supplementary Note 23

The non-transitory recording medium recording a program according to any one of Supplementary Notes 17 to 22, in which the feedback includes a language feedback that is the feedback by language and a binary feedback that is the feedback representing a degree of evaluation as either of a binary value.

### Supplementary Note 24

The non-transitory recording medium recording a program according to any one of Supplementary Notes 17 to 23, in which the trained model is fine-tuned with the first training data and the second training data after being fine-tuned with the third training data.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A generation device to generate training data for fine-tuning of a trained model that simulates a conversation with a user in a natural language, inputs data representing a question issued from the user and data representing feedback from the user, and generates and outputs data representing an answer to the question, the device comprising:
at least one memory storing instructions; and
at least one processor configured to access the at least one memory and execute the instructions to:
generate, based on data representing a history of the conversation, data representing the question, data representing a final answer that is a final answer to the question, and data representing an intermediate answer including information included in the answer output before outputting the final answer;
refer to the intermediate answer;
generate data representing an inference process from the question to the final answer based on the question and the final answer,
wherein the training data includes, as first training data, a plurality of sets of data representing the question as an input to the trained model, data representing the final answer as an output from the trained model, and data representing the inference process.

2. The generation device according to claim 1, wherein
the intermediate answer includes a positive intermediate answer that is the correct answer included in the conversation until outputting the final answer and a negative intermediate answer that is the incorrect answer included in the conversation until outputting the final answer,
the inference process includes a first inference process from the question to the final answer and a second inference process from the negative intermediate answer to the final answer, and
the at least one processor is further configured to execute the instructions to:
refer to the positive intermediate answer; and
generate data representing the first inference process based on the question and the final answer, and generates data representing the second inference process based on the negative intermediate answer and the final answer, wherein
the training data includes, as the first training data, a plurality of sets of data representing the question as an input to the trained model, data representing the final answer as an output from the trained model, and data representing the first inference process, and includes, as second training data, a plurality of sets of data representing the negative intermediate answer as an input to the trained model, data representing the final answer as an output from the trained model, and data representing the second inference process.

3. The generation device according to claim 2, wherein
the at least one processor is further configured to execute the instructions to:
extract data representing background information related to the question and the answer based on the intermediate answer and the feedback in language; and
generate data representing the first inference process and data representing the second inference process with reference to the positive intermediate answer and the background information.

4. The generation device according to claim 3, wherein
the at least one processor is further configured to execute the instructions to:
separate the background information into an inquiry and a response; and
include, in the training data, a set of data representing the inquiry as an input to the trained model and data representing the response as an output from the trained model as third training data.

5. The generation device according to claim 4, wherein
the at least one processor is further configured to execute the instructions to:
evaluate the inference process by comparing the inference process with at least one of the positive intermediate answer, the negative intermediate answer, and the background information.

6. The generation device according to claim 5, wherein
the at least one processor is further configured to execute the instructions to: calculate reliability indicating a degree of the evaluation based on a result of the comparison;
determine that the inference process needs to be corrected in a case where the reliability does not satisfy a predetermined criterion; and
in a case where it is determined that the inference process needs to be corrected, display data representing the inference process in a natural language and correct the data representing the inference process based on an input instruction.

7. The generation device according to claim 6, wherein the feedback includes a language feedback that is the feedback by language and a binary feedback that is the feedback representing a degree of evaluation as either of a binary value.

8. The generation device according to claim 4, wherein the trained model is fine-tuned with the first training data and the second training data after being fine-tuned with the third training data.

9. The generation device according to claim 1, wherein the trained model is an AI model based on machine learning, and the training data is used for fine-tuning the AI model to generate a proposed solution that assists a user's decision making regarding the problem.

10. A generation method of generating training data for fine-tuning of a trained model that simulates a conversation with a user in a natural language, inputs data representing a question issued from the user and data representing feedback from the user, and generates and outputs data representing an answer to the question, the method comprising:
a step of generating, based on data representing a history of the conversation, data representing the question, data representing a final answer that is a final answer to the question, and data representing an intermediate answer including information included in the answer output before outputting the final answer;
a step of referring to the intermediate answer and generating data representing an inference process from the question to the final answer based on the question and the final answer; and
a step of generating the training data including, as first training data, a plurality of sets of data representing the question as an input to the trained model, data representing the final answer as an output from the trained model, and data representing the inference process.

11. A non-transitory recording medium recording a program for generating training data for fine-tuning of a trained model that simulates a conversation with a user in a natural language, inputs data representing a question issued from the user and data representing feedback from the user, generates and outputs data representing an answer to the question, the program causing the computer to execute:
a step of generating, based on data representing a history of the conversation, data representing the question, data representing a final answer that is a final answer to the question, and data representing an intermediate answer including information included in the answer output before outputting the final answer;
a step of referring to the intermediate answer and generating data representing an inference process from the question to the final answer based on the question and the final answer; and
a step of generating the training data including, as first training data, a plurality of sets of data representing the question as an input to the trained model, data representing the final answer as an output from the trained model, and data representing the inference process.
